(19) United States
(12) Patent Application Publication
(10) Pub. No.: US 2025/0165509 A1
(43) Pub. Date: May 22, 2025

(54) INFORMATION PROCESSING DEVICE, INFORMATION PROCESSING METHOD, AND NON-TRANSITORY COMPUTER READABLE STORAGE MEDIUM

(71) Applicant: LY Corporation, Tokyo (JP)

(72) Inventor: Yoshihiro YONEDA, Tokyo (JP)

(21) Appl. No.: 18/908,625

(22) Filed: Oct. 7, 2024

(30) Foreign Application Priority Data
Nov. 20, 2023 (JP) 2023-196882

(51) Int. Cl. G06F 16/332

(52) U.S. Cl. CPC G06F 16/3329

(57) ABSTRACT

An information processing device according to the present application includes an obtaining unit and a provision unit. The obtaining unit obtains logs of a user with respect to a plurality of domains. The provision unit provides, as user information, a log corresponding to a question of the user among the logs that are obtained by the obtaining unit to generative AI.

### CROSS-REFERENCE TO RELATED APPLICATIONS

The present application claims priority to and incorporates by reference the entire contents of Japanese Patent Application No. 2023-196882, filed on Nov. 20, 2023.

### BACKGROUND OF THE INVENTION

### 1. Field of the Invention

The present invention relates to an information processing device, an information processing method, and a non-transitory computer readable storage medium.

### 2. Description of the Related Art

A technique of charging a fee according to a conversion when the conversion occurs via the Internet has been known.
Patent Literature 1: Japanese Laid-open Patent Publication No. 2020-177525

The conventional technique however does not establish a right system of monetization using generative AI and thus does not enable monetization using generative AI appropriately.

### SUMMARY OF THE INVENTION

An information processing device according to the present disclosure includes: an obtaining unit that obtains logs of a user with respect to a plurality of domains; and
a provision unit that provides, as user information, a log corresponding to a question of the user among the logs that are obtained by the obtaining unit to generative AI.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of a configuration of an information processing system according to an embodiment;

FIG. 2 is a diagram illustrating an example of image processing according to the embodiment;

FIG. 3 is a diagram illustrating an example of a configuration of a terminal device according to the embodiment;

FIG. 4 is a diagram illustrating an example of a configuration of a generative AI server according to the embodiment;

FIG. 5 is a diagram illustrating an example of a configuration of an information processing device according to the embodiment;

FIG. 6 is a diagram illustrating an example of a user information storage unit according to the embodiment;

FIG. 7 is a diagram illustrating an example of an advertisement information storage unit according to the embodiment;

FIG. 8 is a diagram illustrating an example of a conversion information storage unit according to the embodiment;

FIG. 9 is a flowchart illustrating an example of information processing according to the embodiment; and

FIG. 10 is a hardware configuration diagram illustrating an example of a computer that implements functions of the information processing device.

### DETAILED DESCRIPTION OF THE PREFERRED EMBODIMENTS

A mode for carrying out an information processing device, an information processing method, and an information processing program (referred to as “embodiment” below) according to the present application will be described in detail below with reference to the accompanying drawings. Note that the embodiment does not limit the information processing device, the information processing method, and the information processing program according to the present application. In each embodiment below, the same parts are denoted with the same reference numerals and redundant description will be omitted.

### EMBODIMENT

### 1. Configuration of Information Processing System

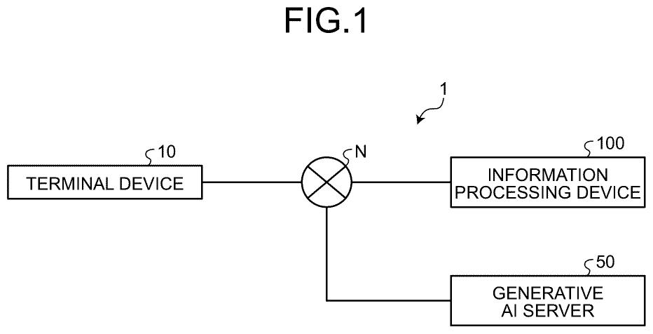

An information processing system 1 illustrated in FIG. 1 will be described. As illustrated in FIG. 1, the information processing system 1 includes a terminal device 10, a generative AI server 50, and an information processing device 100. The terminal device 10, the generative AI server 50, and the information processing device 100 are connected such that communication is enabled in a wired or wireless manner via a given communication network (network N). FIG. 1 is a diagram illustrating an example of a configuration of the information processing system 1 according to the embodiment.

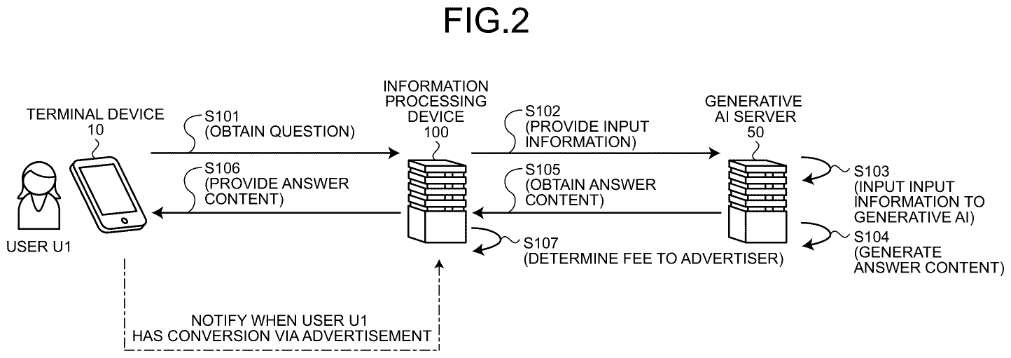

The terminal device 10 is an information processing device that is used by a user who asks a question. For example, the terminal device 10 is used by a user who asks a question in searching and who wants an answer useful for searching. The terminal device 10 may be any device as long as the device is able to realize the processing according to the embodiment. The terminal device 10 may be a device, such as a smartphone, a tablet terminal device, a laptop PC, a desktop PC, a mobile phone, or a PDA. FIG. 2 illustrates the case where the terminal device 10 is a smartphone.

The terminal device 10 is, for example, a smart device, such as a smartphone or a tablet, and is a portable terminal device that is capable of communicating with a given server device via a radio communication network of 4G to 5G (Generation) or LTE (Long Term Evolution). The terminal device 10 includes a screen, such as a liquid crystal display, and that has a touch panel function and the terminal device 10 may receive various types of operations on display data like content, such as a tap operation, a slide operation, or a scroll operation with a finger or a stylus, from the user. According to FIG. 2, the terminal device 10 is used by User U1.

The generative AI server 50 is an information processing device that manages generative AI (provide a platform of generative AI) and the generative AI server 50 may be any device as long as the device is able to realize processing in the embodiment. The generative AI server 50, for example, inputs information that is provided from the information processing device 100 to the generative AI and thereby generates answer content and provides the answer content to the information processing device 100. The answer content includes at least an answer to the question to the user and an advertisement that is selected from advertisements that are determined previously as possible advertisements to be provided together with the answer (for example, an upper advertisement among advertisements listed in a given order). The answer content is information representing the answer to the question to the user and the possible advertisement that is selected from the possible advertisements and the answer content need not be content that is displayed on the terminal device 10 practically. For this reason, the content displayed on the terminal device 10 practically may be generated by the information processing device 100 based on the information on the answer to the question to the user and information on the possible advertisement selected from the possible advertisements.

The generative AI is a writing generative model that is trained with data open on the Internet, etc. For example, the generative AI is a generative pre-trained transformer (GPT) model that generates an answer to a question. Such a model generates an answer to the question from the data open on the Internet. New data is open on the Internet daylily and therefore the answer generated by the model is updated daylily. In other words, even when a question of the same content is asked, data referred by the model to generate an answer differs depending on the time when the question is asked and therefore a different answer is generated. The model is able to give detailed answers to questions of a wide range of fields and therefore the user asks the model a variety of questions.

The information processing device 100 is an information processing device aimed at performing monetization using generative AI appropriately and the information processing device 100 may be any device as long as the device is able to realize processing according to the embodiment. For example, on receiving a question from the user, the information processing device 100 provides information (input information to be input to the generative AI) to the generative AI server 50 in order to generate answer content incorporating an answer to the question to the user. The input information that is input to the generative AI, for example, contains at least text information on the question, possible advertisement information on possible advertisements, user information on the user, and a prompt that provides an instruction to execute information processing using various types of information to the generative AI. The information processing device 100, for example, provides answer content (output information that is output from the generative AI) that is provided from the generative AI server 50 to the user. For example, according to operations performed by the user on the advertisement that is selected as the advertisement to be provided together with the answer (advertisement incorporated in the answer content), the information processing device 100 determines a fee charged to the advertiser of the selected advertisement (a charge to the advertiser). For example, the fee is a fee caused when the user clicks the advertisement and a conversion occurs. In other words, the charge to the advertiser is an affiliate pay-for-performance. The information processing device 100, for example, determines a fee for utilizing the generative AI (a charge to the provider of the generative AI) for utilizing generative AI according to the volume of texts of the question (for example, the number of texts). In other words, the charge to the provider of the generative AI, or the like, (for example, the administrator of the generative AI server 50) is pay-as-you-go. Note that the charge may be based on, not limited to the texts of the question, the volume of all the texts including the texts of the prompt. For this reason, the prompt may be generated such that the texts are short based on a log that is selected according to the user.

FIG. 1 illustrates the case where the generative AI server 50 and the information processing device 100 are different devices; however, the generative AI server 50 and the information processing device 100 may be integrated. For this reason, the information processing device 100 may provide a platform of the generative AI.

### 2. Example of Information Processing

In conventional searching using queries, it is possible to charge an advertiser according to conversions caused by advertisements that are displayed together with the results of searching and, in searching using generative AI, a right system of monetization has not been established and therefore it is has not been possible to perform monetization using generative AI. The present application was made in view of the above-described circumstances and an object of the present application is to perform monetization using generative AI appropriately.

In searching using a query, for example, the order of display of search results is determined based on a bid and a rate of clicks made by the user. On the other hand, searching using generative AI, rules on determining the order of display of search results may be determined previously and, based on the rules, the order of display may be determined or the order of display may be determined based on learning. In the case of determination, for example, data indicating what kind of person purchases and what is purchased may serve as training data. In general generative AI, supervised training that emphasizes fairness using data on the Internet is performed and, when data on a given service can be training data, it is possible to perform learning using data that cannot be known with general generative AI. When the order of display is determined based on learning, even if monetization turns negative, the case sometimes is superior. Note that monetization in which au upper display is made according to a bid is also important and thus rules according to such a bid may be taken into consideration.

As described above, the order of display may be determined using a plurality of rules on page optimization. When an order of display is determined based on learning, for example, an advertisement of an item the user seems to afford (or an item the user seems to want) may be placed in a given space on the UI screen and an advertisement space (sponsor space) may be set as another space and an advertisement of an item corresponding to a bid may be placed. While it is sometimes not preferable as services when an advertisement space is too assertive on the UI screen, placing an advertisement of an item that a user seems to want makes it possible to attract the user who feels worthy of the item. For example, as for electronic commerce (EC), an advertisement on availability may be placed, as for food, an advertisement on accommodation reservations may be placed and, as for recruits, an advertisement on job offering may be placed. Accordingly, it is possible to present availability, reservations, job offers as appropriate according to the content of talk of the user to the generative AI to promote an action. An advertisement of an item corresponding to a concept of values that is selected in a way that a plurality of concepts of values, such as one for surprise, are presented and the user selects a concept may be placed.

There are logs of different services with respect to a plurality of domains, respectively, as the logs of the user. In generation of an answer to the user using the generative AI, when logs of all such domains serve as input information, while it is possible to generate and select content that matches the user, the volume of information can be large and the load can be heavy. In the generative AI, a fee is calculated according to the number of texts that are input and therefore, when the volume of information increases, the fee increases, too. For this reason, it is assumed that the load can be reduced by selecting a log corresponding to a question from the logs that are obtained from the domains and inputting only the selected log as the user information.

FIG. 2 is a diagram illustrating an example of information processing performed by the information processing system 1 according to the embodiment. When User U1 asks a question, the information processing device 100 receives the question from User U1 (step S101). For example, the information processing device 100 receives the question in texts from User U1. In order to generate answer content incorporating an answer to the question to User U1, the information processing device 100 provides information (input information to be input to the generative AI) to the generative AI server 50 (step S102). For example, the information processing device 100 provides, as the input information to the generative AI, possible advertisement information on possible advertisements for selecting an advertisement to be provided to User U1 together with the answer, text information on the question that is received from User U1, user information on User U1, and information on a prompt that makes an instruction to execute information processing using various types of information to the generative AI. The prompt is an instruction document that makes an instruction on what to execute as the information processing using various types of information and is, for example, an instruction document saying “select an advertisement appropriate to User U1”. According to such an instruction document, an advertisement to be incorporated in answer content is selected from the user information on User U1, the possible advertisement information, and the text information of the question. For example, according to an instruction document saying “generate an answer to the question incorporating the content of the selected advertisement”, an answer to be incorporated in answer content is generated from the user information on User U1, the possible advertisement information, and the text information of the question. Note that the prompt may be determined previously or may be generated by the information processing device 100. For example, the prompt may be generated according to the user information on User U1, the question received form User U1, the possible advertisement information, etc.

The prompt contains an instruction document that makes an instruction on what information of the input information input to the generative AI is used to execute the information processing. For example, the prompt may contain an instruction document that makes an instruction on whether possible advertisement information on all advertisements is the subject of selecting an advertisement or possible advertisements are narrowed according to the user information. For example, the prompt contains an instruction document that makes an instruction on what to execute as the information processing using the input information to be input to the generative AI. For example, the prompt may contain an instruction document that makes an instruction on how the user information is used to select an advertisement. As described above, the prompt contains an instruction document that makes an instruction on what information of the input information input to the generative AI is used and how the information is used to execute the information processing.

On obtaining input information to the generative AI from the information processing device 100, the generative AI server 50 inputs input information that is provided from the information processing device 100 to the generative AI (step S103). The generative AI generates answer content based on the input information (step S104). For example, the generative AI generates an answer to the question of User U1 based on the input information and generates answer content incorporating the generated answer. For example, the generative AI selects an advertisement based on the input information and generates answer content incorporating the selected advertisement. For example, the generative AI selects an advertisement based on a log of a domain User U1 often uses among the domain logs of User U1 and generates answer content incorporating the selected advertisement. For example, the generative AI selects an advertisement based on the log that is selected according to the question of User U1 among the domain logs of User U1 and generates answer content incorporating the selected advertisement. In this case, for example, the domain logs of User U1 are domain logs that are generated by associating log data on User U1 with respect to a plurality of domains and are used to generate a prompt for generating an answer to the question of User U1. As described above, log data with respect to a plurality of domains may be associated and, when User U1 asks a question, a prompt for generating an answer for User U1 may be generated. For example, even for the same user and the same and the content of question, a domain may be selected from the domains according to the situation the user is in at that time and the sentences of the question. For example, the generative AI selects an advertisement according to the generated answer to the question of User U1 and generates answer content incorporating the selected advertisement. As described above, the generative AI generates answer content incorporating the advertisement selected according to at least any one of the user information on User U1 and the answer that is generated as the answer to the question of User U1. The generative AI generates answer content incorporating the answer that is generated as the answer to the question of User U1 in a given space (a third space) and an advertisement that is selected from the possible advertisements in a first space. The generative AI generates answer content that incorporates an advertisement selected from the possible advertisements in the first space and an advertisement that is selected based on given information, such as a bid, in a second space.

The generative AI server 50 provides information that is output from the generative AI to the information processing device 100 (step S105). For example, the generative AI server 50 provides answer content that is generated from the generative AI. On obtaining answer content from the generative AI server 50, the information processing device 100 provides the answer content to the terminal device 10 (step S106). On receiving the answer content from the information processing device 100, the terminal device 10 displays the answer content.

On this occasion, User 1 operates (for example, clicks or taps) the advertisement incorporated in the answer content that is displayed on the terminal device 10, so that a conversion occurs. When a conversion occurs, the information processing device 100 stores what advertiser and what advertisement the conversion occurs on. The information processing device 100 then determined a fee to the advertiser according to the number of conversions tallied during a given period (step S107). For example, the information processing device 100 determines a fee to the advertiser such that, the higher the number of conversions is, the higher the fee is. The information processing device 100 charges the advertiser for the determined fee. Not limited to the case where the number of conversions is tallied and a determined fee is charged, the information processing device 100 may charge a fee each time a conversion is made.

In the above-described embodiment, the information processing device 100 may determine a fee for using the generative AI according to the volume of texts of the question received from the User U1. For example, the information processing device 100 may determine a fee for using the generative AI such that the greater the volume is, the higher the fee is. The information processing device 100 may perform processing for paying the provider of the generative AI for the determined fee. A fee for using the generative AI may be determined at any timing, for example, at step S101. The information processing device 100 may determine a fee for using the generative AI according to the volume of texts of questions received from User U1 during a given period. Determining a fee for using the generative AI in this manner and charging the advertiser for the fee according to conversions make it possible to provide a service for free to User U1.

In the above-described embodiment, the information processing device 100 determines a fee for using the generative AI according to the volume of texts of a question and, when User U1 asks a further question to an answer incorporated in the answer content that is provided to User U1, processing for paying the fee for using the generative AI need not be performed with respect to the question to the answer. In other words, the information processing device 100 may determine a fee for using the generative AI with respect to only the first question. An answer to be incorporated in answer content is generated based on a prompt. For this reason, the prompt may be a prompt that makes an instruction to generate an answer to which no further question to the answer is asked and the information processing device 100 may generate such a prompt and provide information on such a prompt. The prompt may be, for example, a prompt that makes an instruction to generate an answer that promotes a conversion and the information processing device 100 may generate such a prompt and provide information on such a prompt. The prompt, for example, may be a prompt that is generated based on a log of domains that User U1 often uses among domain logs of User U1 and the information processing device 100 may generate such a prompt and provide information on such a prompt. The prompt, for example, may be a prompt that is generated based on a log selected according to the question of User U1 among the domain logs of User U1 and the information processing device 100 may generate such a prompt and provide information on such a prompt. The prompt, for example, may be a prompt that makes an instruction such that the volume of advertisement in the first space varies according to the length of interaction of questions and answers between User U1 and the generative AI and the information processing device 100 may generate such a prompt and provide information on such a prompt. The prompt, for example, may be a prompt that is generated such that texts are short according to the log that is selected according to User U1 and the information processing device 100 may generate such a prompt and provide information on such a prompt.

In the above-described embodiment, the case where the information processing device 100 determines a fee to an advertiser and charges the advertiser for the fee has been exemplified and described, and the information processing device 100 may determine a fee to an advertising agency having a given relationship with the advertiser and charge the advertising agency for the fee. In the above-described embodiment, the information processing device 100 determines a fee according to conversions, and the information processing device 100 may determine a fee to the advertising agency according to customer referrals. In other words, a fee the advertising agency is charged according to customer referrals of users to the advertising agency. Note that the advertising agency may have given relationships with a plurality of advertisers.

In the above-described embodiment, the case where the generative AI selects an advertisement from possible advertisements and generate answer content is exemplified and described, and information on conditions for listing advertisements using possible advertisements may be generated. The information processing device 100 may obtain information on conditions for listing from the generative AI server 50, perform listing, and generate answer content.

### 3. Configuration of Terminal Device

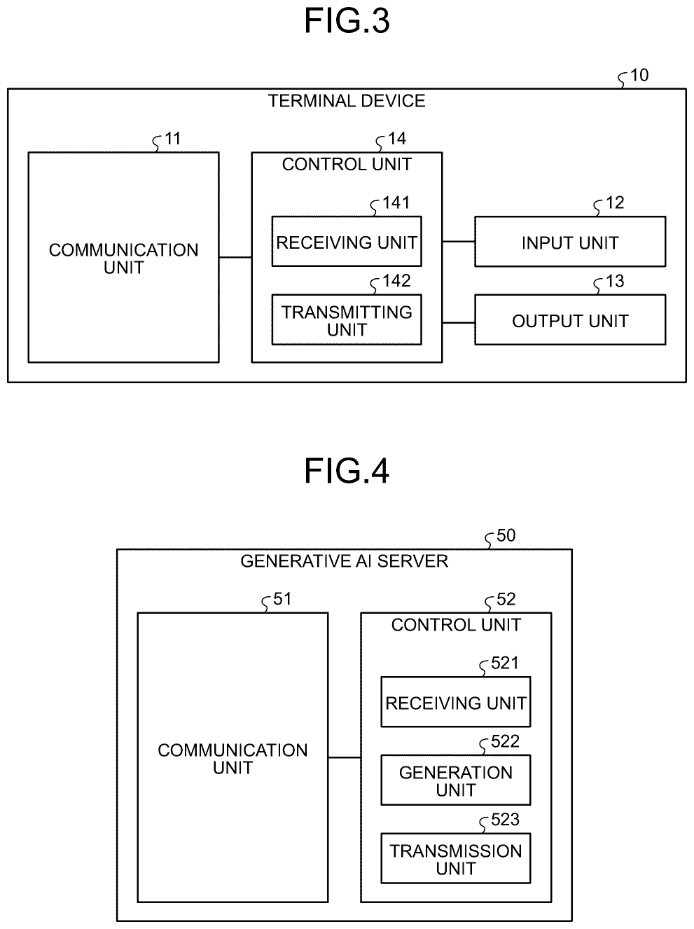

Using FIG. 3, a configuration of the terminal device 10 according to the embodiment will be described next. FIG. 3 is a diagram illustrating an example of the configuration of the terminal device 10 according to the embodiment. As illustrated in FIG. 3, the terminal device 10 includes a communication unit 11, an input unit 12, an output unit 13, and a control unit 14.

### Communication Unit 11

The communication unit 11, for example, is realized by a network interface card (NIC), or the like. The communication unit 11 is connected to a given network N in a wired or wireless manner and transmits and obtains information to and from the information processing device 100, and the like, via the given network N.

### Input Unit 12

The input Unit 12 receives various types of operations from the user. According to FIG. 2, the input unit 12 receives various types of operations from User U1. For example, the input unit 12 may receive various types of information from the user via a display screen using a touch panel function. The input unit 12 may receive various types of information from a button with which the terminal device 10 is provided or a keyboard or a mouse that is connected to the terminal device 10. For example, the input unit 12 receives a text operation for inputting a question.

### Output Unit 13

The output unit 13, for example, is a display screen of a tablet terminal device, or the like, that is realized by a liquid crystal display or an organic electro-luminescence (EL) display and is a display device for displaying various types of information. For example, the output unit 13 displays answer content that is provided from the information processing device 100.

### Control Unit 14

The control unit 14, for example, is a controller and is realized in a way that a central processing unit (CPU), a micro processing unit (MPU), or the like, executes various types of programs that are stored in a storage device in the terminal device 10 using a random access memory (RAN) as a work area. For example, the various types of programs contain a program of an application that is installed in the terminal device 10. For example, the various types of programs contain a program of an application by which answer content provided from the information processing device 100 is displayed. The control unit 14 is realized by, for example, an integrated circuit, such as an application specific integrated circuit (ASIC) or a field programmable gate array (FPGA).

As illustrated in FIG. 3, the control unit 14 includes a receiving unit 141 and a transmitting unit 142 and realizes or executes operations of information processing described below.

### Receiving Unit 141

The receiving unit 141, for example, receives answer content that is provided from the information processing device 100. For example, the receiving unit 141 receives answer content incorporating an answer that is generated by the generative AI as an answer to a question of the user. For example, the receiving unit 141 receives answer content incorporating an advertisement that is selected by the generative AI as an advertisement to be provided to the user.

### Transmitting Unit 142

The transmitting unit 142 transmits text information on the question that is input by the user to the terminal device 10. For example, the transmitting unit 142 transmits text information on the question that is input on a UI screen for making a question for the first time. For example, the transmitting unit 142 also transmits text information on the question that is input on a UI screen for the user to make a further question to the answer content that is provided. Note that the transmitting unit 142 may transmit user information on the user who asks the question.

### 4. Configuration of Generative AI Server

Using FIG. 4, a configuration of the generative AI server 50 according to the embodiment will be described next. FIG. 4 is a diagram illustrating an example of the configuration of the generative AI server 50 according to the embodiment. As illustrated in FIG. 4, the generative AI server 50 includes a communication unit 51 and a control unit 52. The generative AI server 50 may include an input unit (for example, a keyboard or a mouse) that receives various types of operations from the administrator of the generative AI server 50 and a display unit (for example, a liquid crystal display) for displaying various types of information.

### Communication Unit 51

The communication unit 51, for example, is realized by a NIC, or the like. The communication unit 51 is connected to the network N in a wired or wireless manner and transmits and obtains information to and from the information processing device 100 via the network N.

### Control Unit 52

The control unit 52, for example, is a controller and is realized in a way that a CPU, a MPU, or the like, executes various types of programs that are stored in a storage device in the generative AI server 50 using a RAM as a work area. The control unit 52 is realized by, for example, an integrated circuit, such as an ASIC or a FPGA.

As illustrated in FIG. 4, the control unit 52 includes a receiving unit 521, a generation unit 522, and a transmission unit 523 and realizes or executes operations of information processing described below. An internal configuration of the control unit 52 is not limited to the configuration illustrated in FIG. 4, and the configuration may be another configuration as long as the configuration performs the information processing described below.

### Receiving Unit 521

The receiving unit 521, for example, receives information that is provided from the information processing device 100. For example, the receiving unit 521 receives text information on a question that is input by the user. For example, the receiving unit 521 receives possible advertisement information for selecting an advertisement to be provided to the user (the user who asks the question). For example, the receiving unit 521 receives user information on the user (the user who asks the question). For example, the receiving unit 521 receives prompt information that is generated by the information processing device 100. As described above, the receiving unit 521, for example, receives the text information on a question, the possible advertisement information, the user information, and the prompt information. Note all these sets of information are input to the generative AI.

### The Generation Unit 522

The generation unit 522, for example, inputs the information that is provided from the information processing device 100 to the generative AI to generate answer content. For example, the generation unit 522 generates an answer to be incorporated in the answer content. For example, the generation unit 522 regards an answer that is output from the generative AI as an answer to be incorporated in the answer content. For example, the generation unit 522 selects an advertisement to be incorporated in the answer content. For example, the generation unit 522 regards an advertisement that is output from the generative AI as an advertisement to be incorporated in the answer content. For example, the generation unit 522 regards an advertisement that is output from the generative AI as an advertisement to be incorporated in a first space of the answer content. For example, the generation unit 522 may generate answer content incorporating the advertisement that is output from the generative AI in a first space and an advertisement that is selected based on given information, such as a bid, in a second space.

### Transmission Unit 523

The transmission unit 523, for example, provides the answer content that is generated by the generation unit 522 to the information processing device 100. For example, the transmission unit 523 provides information that is output from the generative AI. For example, the transmission unit 523 provides information on the answer that is output from the generative AI and information on the advertisement that is output from the generative AI.

### 5. Configuration of Information Processing Device

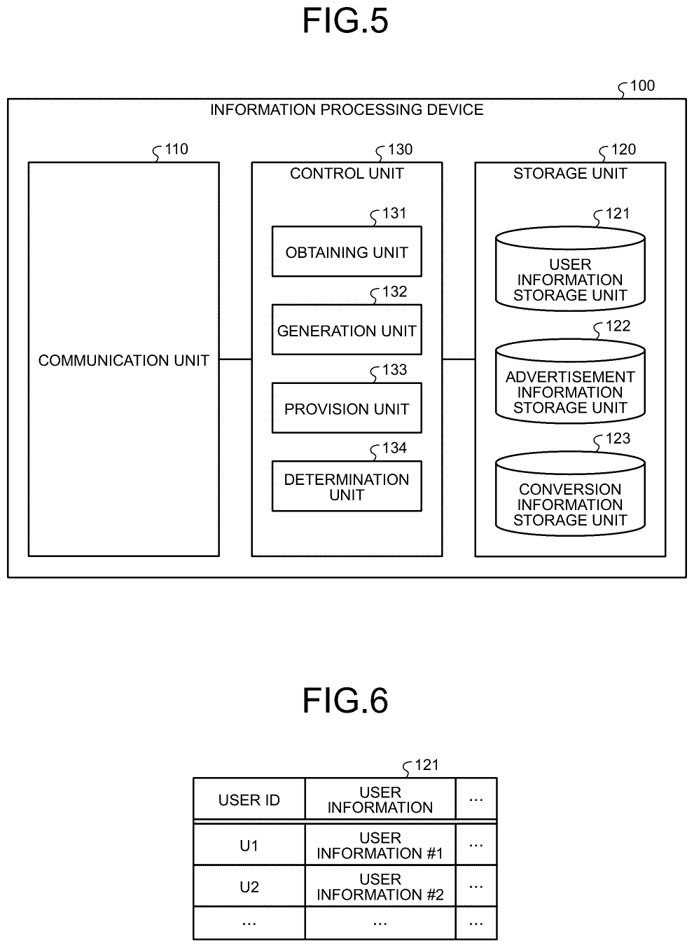

Using FIG. 5, a configuration of the information processing device 100 according to the embodiment will be described. FIG. 5 is a diagram illustrating an example of the configuration of the information processing device 100 according to the embodiment. As illustrated in FIG. 5, the information processing device 100 includes a communication unit 110, a storage unit 120, and a control unit 130. Note that the information processing device 100 may include an input unit (for example, a keyboard or a mouse) that receives various types of operations from an administrator of the information processing device 100 and a display unit (for example, a liquid crystal display) for displaying various types of information.

### Communication Unit 110

The communication unit 110, for example, is realized by a NIC, or the like. The communication unit 110 is connected to the network N in a wired or wireless manner and transmits and obtains information to and from the terminal device 10, the generative AI server 50, or the like, via the network N.

### Storage Unit 120

The storage unit 120 is realized by a semiconductor memory device, such as a RAM or a flash memory, or a storage device, such as a hard disk or an optical disk. As illustrated in FIG. 5, the storage unit 120 includes a user information storage unit 121, an advertisement information storage unit 122, and a conversion information storage unit 123.

The user information storage unit 121 stores the user information. For example, the user information storage unit 121 stores information representing an attribute, taste and preference and an action record of the user, etc. FIG. 6 illustrates an example of the user information storage unit 121 according to the embodiment. The information stored in the user information storage unit 121, for example, is used to generate answer content. As illustrated in FIG. 6, the user information storage unit 121 has items of “user ID” and “user information”.

A “user ID” represents identification information for identifying the user. “User information” represents user information. As for the example illustrated in FIG. 6, the example where ideational information of “user information #1” and “user information #2” is stored in “user information” is illustrated and, practically, information representing attributes, such as the age, the gender, and the residential address of the user, information representing the taste and preference, information representing the action record, and the like, are stored.

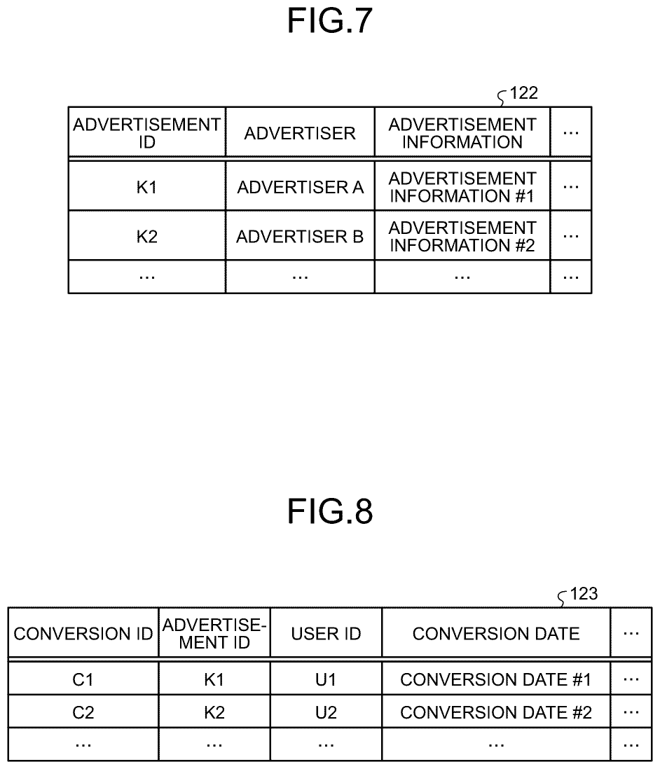

The advertisement information storage unit 122 stores advertisement information. For example, the advertisement information storage unit 122 stores information representing an advertiser and a category and target users of advertisements and image data of the advertisements. The information stored in the advertisement information storage unit 122, for example, is used to generate answer content. FIG. 7 illustrates an example of the advertisement information storage unit 122 according to the embodiment. As illustrated in FIG. 7, the advertisement information storage unit 122 has items of “advertisement ID”, “advertiser”, and “advertisement information”.

An “advertisement ID” represents identification information for identifying an advertisement. An “advertiser” represents an advertiser. “Advertisement information” represents advertisement information. As for the example illustrated in FIG. 7, the example where ideational information of “advertisement information #1” and “advertisement information #2” is stored in “advertisement information” is illustrated and, practically, image data, and the like, are stored. For example, a URL in which image data is located, and a file path name representing a site of storage may be stored.

The conversion information storage unit 123 stores conversion information. For example, the conversion information storage unit 123 stores information representing the user who makes a conversion and an advertisement on which the conversion is performed. The information stored in the conversion information storage unit 123, for example, is used to count the number of conversions or determine a fee to the advertiser. FIG. 8 illustrates an example of the conversion information storage unit 123 according the embodiment. As illustrated in FIG. 8, the conversion information storage unit 123 has items of “conversion ID”, “advertisement ID”, “user ID”, and “conversion date”.

A “conversion ID” represents identification information for identifying a conversion. An “advertisement ID” represents identification information for identifying an advertisement. A “user ID” represents identification information for identifying the user. A “conversion date” represents a date of conversion. As for the example illustrated in FIG. 8, the example where ideational information of “conversion date #1” and “conversion date #2” is stored in “conversion date” and, practically, information representing a date, and the like, are stored.

### Control Unit 130

The control unit 130 is a controller and, for example, is realized in a way that a CPU, a MPU, or the like, executes various types of programs that are stored in a storage device in the information processing device 100 using a RAM as a work area. The control unit 130 is realized by, for example, an integrated circuit, such as an ASIC or a FPGA.

As illustrated in FIG. 5, the control unit 130 includes an obtaining unit 131, a generation unit 132, a provision unit 133, and a determination unit 134 and realizes or executes operations of information processing described below. An internal configuration of the control unit 130 is not limited to the configuration illustrated in FIG. 5, and the configuration may be another configuration as long as the configuration performs the information processing described below.

### Obtaining Unit 131

The obtaining unit 131 obtains various types of information from the storage unit 120. The obtaining unit 131 stores various types of information that are obtained in the storage unit 120.

The obtaining unit 131 obtains various types of information from an external information processing device. The obtaining unit 131 obtains various types of information from an external information processing device, such as the terminal device 10.

The obtaining unit 131 obtains text information on a question that is input by the user and thereby receives the question from the user. For example, the obtaining unit 131 obtains text information on the question that is input by the user on the UI screen for asking a question for the first time and thereby receives the first question from the user. For example, the obtaining unit 131 also obtains text information on a question that is input by the user on the UI screen for asking for a further question to answer content and thereby receives the further question from the user. When the user operates an advertisement contained in the answer content and accordingly a conversion occurs, the obtaining unit 131 obtains information on the conversion that occurs.

The obtaining unit 131, for example, obtains logs of the user. For example, the obtaining unit 131 obtains logs of the user with respect to a plurality of domains. For example, the obtaining unit 131 obtains logs of the user with respect to a plurality of domains as the user information.

### Generation Unit 132

On receiving the question from the user via the obtaining unit 131 (on obtaining the text information on the question), the generation unit 132 makes possible advertisements, the question (the text information on the question), the user information, and the prompt information input to the generative AI and thereby causes the generative AI to generate answer content. For example, the generation unit 132 provides possible advertisement information, texts of the question, the user information, and the prompt information to the generative AI server 50 and thereby causes the generative AI server 50 to input the information to the generative AI to cause the generative AI to generate answer content. For example, the generation unit 132 causes the generative AI to generate an answer to be incorporated in answer content to be provided to the user who asks the question. For example, the generation unit 132 causes the generative AI to select an advertisement to be incorporated in answer content to be provided to the user who asks the question from the possible advertisements. The generation unit 132, for example, causes the generative AI server 50 to provide answer content that the generative AI is caused to generate to the information processing device 100.

### Provision Unit 133

The provision unit 133 provides the answer content that the generative AI is caused to generate to the terminal device 10 and thereby provides the answer content to the user. For example, the provision unit 133 provides information on the answer that the generative AI is caused to generate. For example, the provision unit 133 provides the answer content incorporating the answer that the generative AI is caused to generate. For example, the provision unit 133 provides the answer content that is generated based on the information on the answer that the generative AI is caused to generate. For example, the provision unit 133 obtains the information on the answer from the generative AI server 50 and provides the answer content that is generated based on the obtained information on the answer. For example, the provision unit 133 provides the information on the advertisement that the generative AI is caused to select. The provision unit 133 provides the answer content incorporating the advertisement that the generative AI is caused to select. For example, the provision unit 133 provides the answer content that is generated based on the information on the advertisement that the generative AI is caused to select. For example, the provision unit 133 obtains the information on the advertisement from the generative AI server 50 and provides the answer content that is generated based on the obtained information on the advertisement.

The provision unit 133, for example, provides the logs of the user that are obtained by the obtaining unit 131 to the generative AI server 50. For example, the provision unit 133 provides, as the user information, a log that meets a given condition among the logs of the user that are obtained by the obtaining unit 131. For example, the provision unit 133 provides, as the user information, a log corresponding to the question of the user among the logs of the user that are obtained by the obtaining unit 131. Note that the log that meets the given condition is, for example, a log that is selected as a log to be input to the generative AI. The log that meets the given condition is, for example, a log that is selected as a log for causing the generative AI to generate answer content. The log that meets the given condition is, for example, a log that is selected as a log for causing the generative AI to generate answer content incorporating a given advertisement in a first space and an advertisement selected based on a bid from the possible advertisements in a second space.

### Determination Unit 134

The determination unit 134, for example, determines a fee to the advertiser according to operations performed by the user on the advertisement contained in the answer content that is provided by the provision unit 133. For example, the determination unit 134 determines a fee to the advertiser according to the number of conversions corresponding to operations of the user on the advertisement incorporated in the answer content. The determination unit 134, for example, charges the advertiser for the fee that is determined as described above. The determination unit 134, for example, determines a fee for using the generative AI according to a volume of texts presented by the text information that is obtained by the obtaining unit 131. The determination unit 134 then, for example, may perform processing for paying the fee that is determined as described above to the provider of the generative AI, or the like.

### 6. Flow of Information Processing

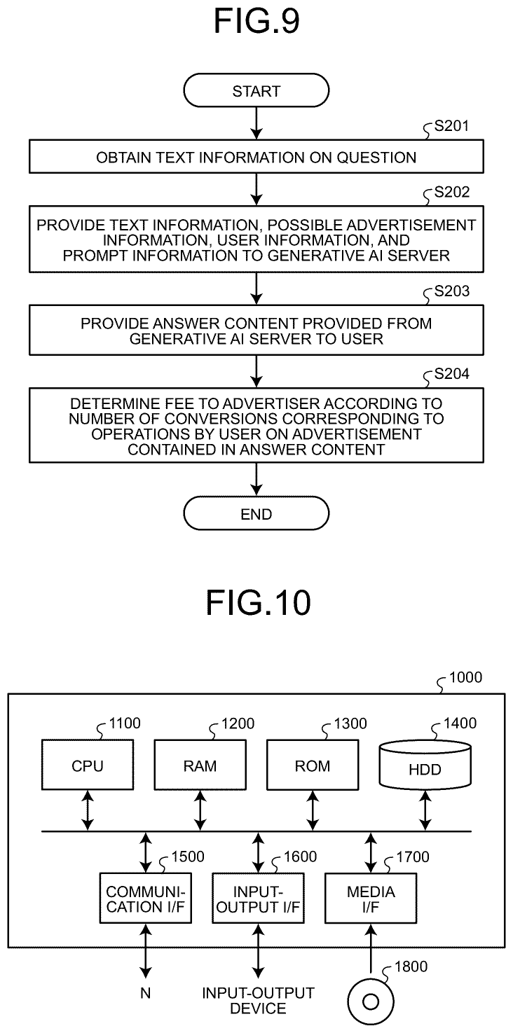

Using FIG. 9, a procedure of information processing performed by the information processing system 1 according to the embodiment will be described next. FIG. 9 is a flowchart illustrating the procedure of the information processing performed by the information processing system 1 according to the embodiment.

As illustrated in FIG. 9, the information processing device 100 obtains text information on a question that is input by a user (step S201).

The information processing device 100 provides the obtained text information, possible advertisement information, user information, and prompt information to the generative AI server 50 and thereby the information is input to the generative AI to cause the generative AI to generate answer content (step S202).

The information processing device 100 provides the answer content that the generative AI is caused to generate (in other words, the answer content that is provided from the generative AI server 50) to the user (step S203).

The information processing device 100 determines a fee to an advertiser according to the number of conversions corresponding to operations performed by the user on an advertisement that is contained in the provided answer content (step S204).

### 7. Effect

As described above, the information processing device 100 according to the embodiment includes the obtaining unit 131 and the provision unit 133. The obtaining unit 131 obtains logs of the user with respect to a plurality of domains. The provision unit 133 provides, as user information, a log corresponding to a question of the user among the logs that are obtained by the obtaining unit 131 to the generative AI.

Thus, the information processing device 100 according to the embodiment, for example, incorporates an advertisement in answer content that is output by generative AI and thus is able to charge a fee according to conversions and therefore it is possible to perform monetization using the generative AI appropriately.

The provision unit 133 provides, as user information, a log that is selected as a log to be input to the generative AI to the generative AI.

Thus, the information processing device 100 according to the embodiment, for example, is able to provide the log to be input to the generative AI appropriately as user information.

The provision unit 133 provides, as the user information, a log that is selected as a log for causing the generative AI to generate answer content to the generative AI.

Thus, the information processing device 100 according to the embodiment, for example, is able to provide, as the user information, the log for causing the generative AI to generate answer content.

The provision unit 133 provides, as the user information, a log that is selected as a log for causing the generative AI to generate the answer content incorporating an answer to the question to the generative AI.

Thus, the information processing device 100 according to the embodiment, for example, is able to provide, as the user information, the log for causing the generative AI to generate the answer content incorporating an answer to the question.

The provision unit 133 provides, as the user information, a log that is selected as a log for causing the generative AI to generate the answer content incorporating an advertisement aimed at a conversion to the generative AI.

Thus, the information processing device 100 according to the embodiment, for example, is able to appropriately provide, as the user information, the log for causing the generative AI to generate the answer content incorporating the advertisement aimed at a conversion.

The provision unit 133 provides, as the user information, a log that is selected as a log for causing the generative AI to generate the answer content incorporating the advertisement in a first space and an advertisement that is selected based on a bid from possible advertisements in a second space to the generative AI.

Thus, the information processing device 100 according to the embodiment, for example, is able to provide, as the user information, the log for causing the generative AI to generate the answer content incorporating a given advertisement in a first space and an advertisement that is selected based on a bid from possible advertisements in a second space.

### 8. Hardware Configuration

The information processing device 100 according to the above-described embodiment is realized by, for example, a computer 1000 having a configuration like that illustrated in FIG. 10. FIG. 10 is a hardware configuration diagram illustrating an example of a computer that realizes the functions of the information processing device 100. The computer 1000 includes a CPU 1100, a RAM 1200, a ROM 1300, a HDD 1400, a communication interface (I/F) 1500, an input-output interface (I/F) 1600 and a media interface (I/F) 1700.

The CPU 1100 operates according to programs that are stored in the ROM 1300 or the HDD 1400 and controls each unit. The ROM 1300 stores a boot program that is executed by the CPU 1100 to start the computer 1000, a program that is dependent on hardware of the computer 1000, etc.

The HDD 1400 stores a program that is executed by the CPU 1100, data that is used by the program, etc. The communication interface 1500 receives data from another device and transmits the data to the CPU 1100 via a given communication network and transmits data that is generated by the CPU 1100 to another device via the given communication network.

The CPU 1100 controls an output device, such as a display or a printer, and an input device, such as a keyboard or a mouse, via the input-output interface 1600. The CPU 1100 obtains data from the input device via the input-output interface 1600. The CPU 1100 outputs generated data to the output device via the input-output interface 1600.

The media interface 1700 reads a program or data that is stored in a recording medium 1800 and provides the program or the data to the CPU 1100 via the RAM 1200. The CPU 1100 loads the program from the recording medium 1800 into the RAM 1200 via the media interface 1700 and executes the loaded program. The recording medium 1800 is, for example, an optical recording medium, such as a digital versatile disc (DVD) or a phase change rewritable disk (PD), a magneto-optical recording medium, such as a magneto-optical disk (MO), a tape medium, a magnetic recording medium, or a semiconductor memory.

For example, when the computer 1000 functions as the information processing device 100 according to the embodiment, the CPU 1100 of the computer 1000 executes the program that is loaded into the RAM 1200 to implement the function of the control unit 130. The CPU 1100 of the computer 1000 reads the programs from the recording medium 1800 and executes the programs and, in another example, the CPU 1100 may obtain the programs from another device via the given communication network.

### 9. Remarks

Among the processes described in the above-described embodiments, all or part of processes that are described as being performed automatically may be performed manually or all or part of processes that are described as being performed manually may be performed automatically by a known method. Furthermore, the procedures, specific names, and information incorporating various types of data and parameters that are presented in the document and drawings are changeable optionally except as otherwise provided. For example, the various types of information presented in each drawing is not limited to the information illustrated in the drawings.

Each of the components of each of the devices illustrated in the drawings is of functional concepts and need not necessarily be configured physically as illustrated in the drawings. In other words, specific modes of distribution and integration of each device are not limited to those illustrated in the drawings, and all or part of the devices may be configured by being distributed or integrated functionally or physically in any unit and according to various types of loads and the circumstances in which the devices are used.

It is also possible to combine the above-described embodiments as appropriate as long as no inconsistency is caused in the content of the processes.

Some embodiments of the present application have been described in detail according to the drawings; however, the embodiments are exemplary only and it is possible to carry out the present invention, starting with the mode described in the disclosure part, in other modes where various modifications and improvements are made based on the knowledge of those skilled in the art.

The above-described “section, module or unit” may be read as “means”, “circuit” or the like. For example, the obtaining unit may be read as an obtaining means or obtaining circuitry.

According to a mode of an embodiment, an effect that it is possible to perform monetization using generative AI is made.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing device including:
an obtaining unit that obtains logs of a user with respect to a plurality of domains; and
a provision unit that provides, as user information, a log corresponding to a question of the user among the logs that are obtained by the obtaining unit to generative AI.

2. The information processing device according to claim 1, wherein the provision unit provides, as the user information, a log that is selected as a log to be input to the generative AI to the generative AI.

3. The information processing device according to claim 1, wherein the provision unit provides, as the user information, a log that is selected as a log for causing the generative AI to generate answer content to the generative AI.

4. The information processing device according to claim 3, wherein the provision unit provides, as the user information, a log that is selected as a log for causing the generative AI to generate the answer content incorporating an answer to the question to the generative AI.

5. The information processing device according to claim 3, wherein the provision unit provides, as the user information, a log that is selected as a log for causing the generative AI to generate the answer content incorporating an advertisement aimed at a conversion to the generative AI.

6. The information processing device according to claim 5, wherein the provision unit provides, as the user information, a log that is selected as a log for causing the generative AI to generate the answer content incorporating the advertisement in a first space and an advertisement that is selected based on a bid from possible advertisements in a second space to the generative AI.

7. An information processing method that is executed by a computer, the method including:
obtaining logs of a user with respect to a plurality of domains; and
providing, as user information, a log corresponding to a question of the user among the logs that are obtained by the obtaining to generative AI.

8. A non-transitory computer readable storage medium having stored an information processing program that causes a computer to execute:
obtaining logs of a user with respect to a plurality of domains; and
providing, as user information, a log corresponding to a question of the user among the logs that are obtained by the obtaining to generative AI.
